(19) United States
(12) Patent Application Publication
(10) Pub. No.: US 2017/0101150 A1
(43) Pub. Date: Apr. 13, 2017

(54) SADDLE RIDING TYPE VEHICLE

(71) Applicant: Yamaha Hatsudoki Kabushiki Kaisha, Iwata-shi, Shizuoka (JP)

(72) Inventors: Yu SHIBUYA, Shizuoka (JP); Takashi KAIEDA, Shizuoka (JP)

(21) Appl. No.: 15/128,454

(22) PCT Filed: Mar. 16, 2015
(86) PCT No.: PCT/JP2015/057635

§ 371 Date: Sep. 23, 2016

(30) Foreign Application Priority Data
Mar. 24, 2014 (JP) 2014-060804

(51) Int. Cl. B62J 99/00; B62K 23/02; B62K 5/08; B62K 5/10; B62K 5/027; B62K 5/05

(52) U.S. Cl. CPC B62J 99/00; B62K 5/027; B62K 5/05; B62K 5/08; B62K 5/10; B62K 23/02; B62K 2005/001

(57) ABSTRACT

A saddle riding type vehicle prevents a difference between an actual state of a linkage and a state of the linkage recognized by the rider. The saddle riding type vehicle includes a vehicle body frame, a pair of front wheels, a linkage, a lock, a controller, and a notifier. The linkage connects the pair of front wheels to the vehicle body frame. The lock locks the linkage by preventing operation of the linkage and unlocks the linkage by allowing the linkage to operate. The controller controls locking and unlocking of the linkage by the lock. The notifier notifies the rider when the vehicle travels and the lock has locked the linkage.

### BACKGROUND OF THE INVENTION

1. Field of the Invention

The present invention relates to saddle riding type vehicles and more particularly to a saddle riding type vehicle including a pair of front wheels.

2. Description of the Related Art

An example of a saddle riding type vehicle is a three-wheeled vehicle including a pair of front wheels and a linkage that connects the pair of front wheels to a vehicle body frame. The three-wheeled vehicle is able to turn while leaning by the operation of the linkage.

JP 2005-313876 A discloses an anti-roll device for a three-wheeled vehicle. The anti-roll device includes a brake disk provided integrally with one element of the linkage and a caliper attached to a vehicle body frame. In the anti-roll device, the caliper is used to fix the brake disk to the vehicle body frame. In this way, the operation of the linkage is restricted. This prevents a rolling motion of the vehicle.

The operability of the vehicle greatly differs depending on whether the operation of the linkage is restricted or not. Therefore, the rider often drives the vehicle while being aware of whether the operation of the linkage is restricted. An actual state of the vehicle and the state recognized by the rider may be different in some cases.

### SUMMARY OF THE INVENTION

Preferred embodiments of the present invention provide a saddle riding type vehicle that is less likely to cause a difference between an actual state of the linkage and a state recognized by the rider.

A saddle riding type vehicle according to a first preferred embodiment of the present invention includes a vehicle body frame, a pair of front wheels, a linkage, a lock, a controller, and a notifier. The linkage connects the pair of front wheels to the vehicle body frame. The lock locks the linkage by preventing operation of the linkage and unlocks the linkage by allowing the linkage to operate. The controller controls locking and unlocking of the linkage via the lock. The notifier notifies the rider when the vehicle travels and the lock has locked the linkage.

While the vehicle travels, the rider must watch the surroundings around the vehicle. Therefore, the rider sometimes may not correctly understand a locked state of the linkage. According to a preferred embodiment of the present invention, if the vehicle travels when the lock has locked the linkage, the notifier notifies this state to the rider.

Therefore, there is little or no difference between an actual state of the linkage and the state recognized by the rider.

According to a preferred embodiment of the present invention, the notifier notifies the rider when the vehicle travels at a prescribed speed or more and the lock has locked the linkage. In this way, the locked state of the linkage is notified to the rider appropriately.

According to a preferred embodiment of the present invention, the notifier notifies the rider when the vehicle has traveled for a prescribed period and the lock has locked the linkage. In this way, the locked state of the linkage is notified to the rider appropriately.

According to a preferred embodiment of the present invention, the notifier notifies the rider that the linkage is locked by the lock if the lock locks the linkage and then the vehicle travels for a prescribed period at a vehicle speed lower than a vehicle speed at the time of locking of the linkage. In this way, the locked state of the linkage is notified to the rider appropriately.

According to a preferred embodiment of the present invention, the saddle riding type vehicle further includes a notifying condition determiner and a notifying controller. The notifying condition determiner determines whether a notifying condition for notifying a locked state of the linkage is fulfilled based on at least one of a vehicle speed and traveling time while the lock locks the linkage. The notifying controller controls the notifier to notify the rider of the locked state of the linkage if the notifying condition is fulfilled. In this way, the locked state of the linkage is notified to the rider appropriately.

According to a preferred embodiment of the present invention, the saddle riding type vehicle further includes a damper. The damper damps vibrations in opposite phases generated in the pair of front wheels. The lock locks the linkage by preventing operation of the damper and unlocks the linkage by allowing the damper to operate.

According to a preferred embodiment of the present invention, an additional lock is not necessary. Therefore, a compact saddle riding type vehicle is achieved.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a left side view of a general structure of a saddle riding type vehicle according to a preferred embodiment of the present invention.

FIG. 2 is a front view of a general structure of a linkage.

FIG. 3 is a diagram of a hydraulic circuit for a damper.

FIG. 4 is a block diagram for illustrating signals input/output to/from a controller.

FIG. 5 is a flowchart for illustrating locking control by a lock controller.

FIG. 6 is a flowchart for illustrating notifying control by a notifying controller.

### DETAILED DESCRIPTION OF THE PREFERRED EMBODIMENTS

Now, saddle riding type vehicles according to preferred embodiments of the present invention will be described in conjunction with the accompanying drawings in which the same or corresponding portions are designated by the same reference characters and their description will not be repeated. Note that the saddle riding type vehicle may be a scooter type vehicle, for example.

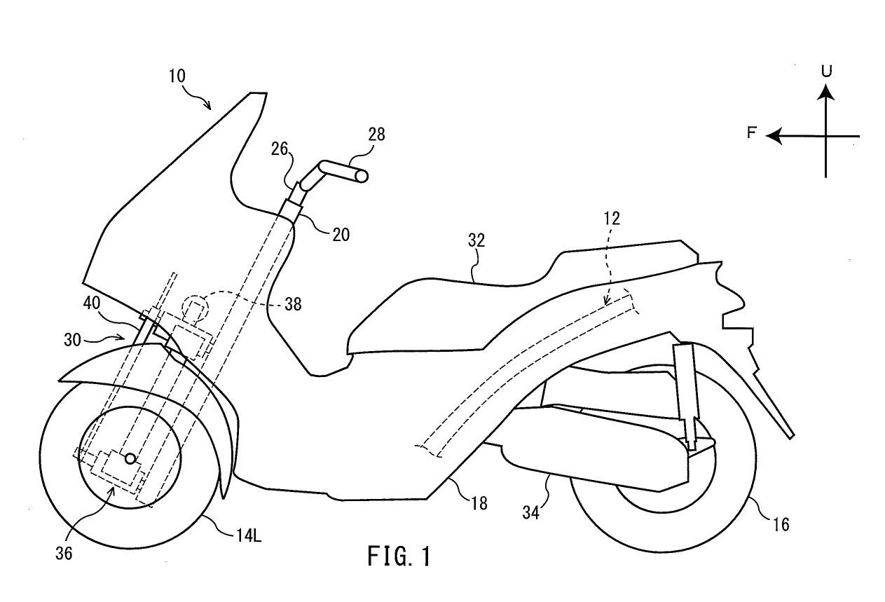

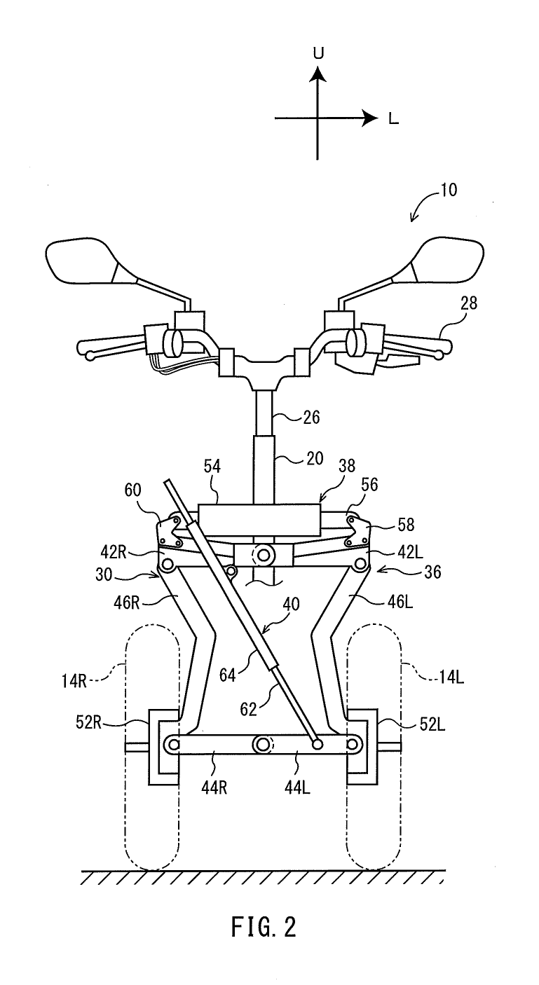

FIG. 1 is a left side view of a general structure of a saddle riding type vehicle 10 according to a preferred embodiment of the present invention. FIG. 2 is a front view of a general structure of a linkage provided in the saddle riding type vehicle 10. In the following description, the front, back, left, and right refer to these positions as seen by the rider seated on a seat 32 of the saddle riding type vehicle 10. In FIG. 1, the arrow F indicates a forward direction of the saddle riding type vehicle 10 and the arrow U indicates an upward direction of the saddle riding type vehicle 10. In FIG. 2, the arrow L indicates a leftward direction of the saddle riding type vehicle 10 and the arrow U indicates the upward direction of the saddle riding type vehicle 10.

As shown in FIG. 1, the saddle riding type vehicle 10 includes a vehicle body frame 12, a pair of front wheels 14L and 14R, and a rear wheel 16.

As shown in FIG. 1, the vehicle body frame 12 is covered with a vehicle cover 18. As shown in FIG. 1, the vehicle body frame 12 includes a head pipe 20.

As shown in FIG. 1, the head pipe 20 is provided at a front portion of the vehicle body frame 12. As shown in FIGS. 1 and 2, the head pipe 20 includes a steering shaft 26 inserted therethrough. As shown in FIGS. 1 and 2, the steering shaft 26 includes a handle 28 at its upper end.

As shown in FIG. 1, a front wheel support 30 is provided in front of the head pipe 20. As shown in FIG. 2, the front wheel support 30 supports the pair of front wheels 14L and 14R. The front wheel support 30 will be described in detail below.

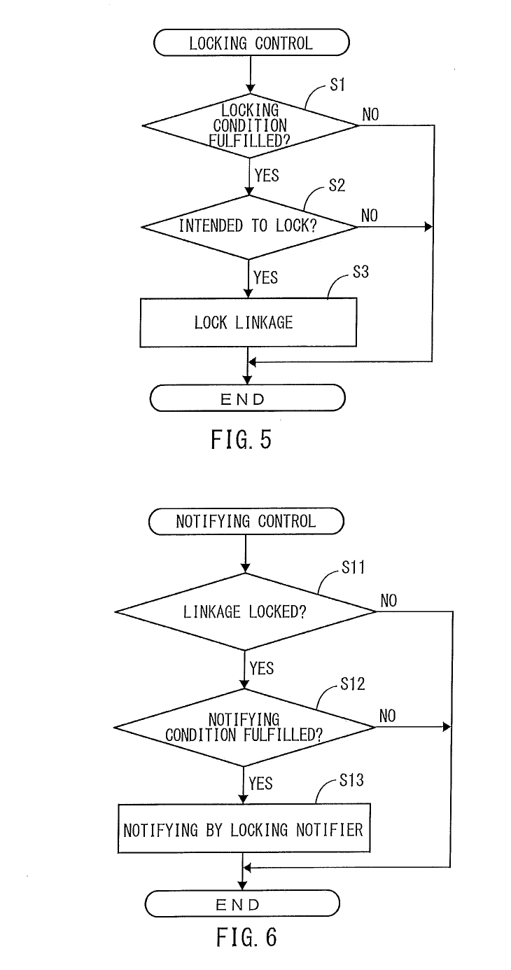

As shown in FIG. 1, the rear wheel 16 is provided below the seat 32. The seat 32 is provided above the vehicle body frame 12. The driving force of an engine 94 (see FIG. 5) is transmitted to rotate the rear wheel 16.

Referring to FIG. 2, the front wheel support 30 will be described. The front wheel support 30 includes a linkage 36, a suspension 38, and a damper 40.

The linkage 36 connects the pair of front wheels 14L and 14R to the vehicle body frame 12 (for example, to a front frame provided in front of the head pipe 20). The linkage 36 includes an upper left arm 42L, an upper right arm 42R, a lower left arm 44L, a lower right arm 44R, a left knuckle arm 46L, and a right knuckle arm 46R.

One of the upper left arm 42L and the upper right arm 42R is able to swing relative to the other around an axial line through a swing center that extends in the front-back direction of the vehicle. The lower left arm 44L is provided under the upper left arm 42L. The lower right arm 44R is provided under the upper right arm 42R. One of the lower left arm 44L and the lower right arm 44R is able to swing relative to the other around an axial line through a swing center that extends in the front-back direction of the vehicle.

The left knuckle arm 46L extends in the vertical direction of the vehicle to connect a left end of the upper left arm 42L and a left end of the lower left arm 44L. The left knuckle arm 46L is able to swing relative to the upper left arm 42L and the lower left arm 44L around an axial line through a swing center that extends in the front-back direction of the vehicle. Therefore, the left knuckle arm 46L is able to move in the vertical direction.

The right knuckle arm 46R extends in the vertical direction of the vehicle to connect a right end of the upper right arm 42R and a right end of the lower right arm 44R. The right knuckle arm 46R is able to swing relative to the upper right arm 42R and the lower right arm 44R around an axial line through a swing center that extends in the front-back direction of the vehicle. Therefore, the right knuckle arm 46R is able to move in the vertical direction.

At a lower end of the left knuckle arm 46L, a front wheel support member 52L is able to swing around an axial line through a swing center that extends in the vertical direction of the vehicle. The front wheel support member 52L supports the front wheel 14L in a rotatable manner.

At a lower end of the right knuckle arm 46R, a front wheel support member 52R is able to swing around an axial line through a swing center that extends in the vertical direction of the vehicle. The front wheel support member 52R supports the front wheel 14R in a rotatable manner.

The front wheel support members 52L and 52R rotate in a plan view as the handle 28 is operated. In this way, the saddle riding type vehicle 10 is able to turn to the left and right.

As shown in FIG. 2, the suspension 38 is connected to the linkage 36. The suspension 38 includes a cylinder 54 and a piston 56.

The cylinder 54 is attached to a right end of the upper right arm 42R through a bracket 60. The cylinder 54 is able to swing relative to the upper right arm 42R. The cylinder 54 stores operating oil.

The piston 56 is attached to a left end of the upper left arm 42L through a bracket 58. Here, the bracket 58 is fixed to the upper left arm 42L. The piston 56 is able to swing relative to the bracket 58. Therefore, the piston 56 is able to swing relative to the upper left arm 42L.

The piston 56 is able to move in an axial direction of the cylinder 54. The piston 56 includes a main body (not shown) provided inside the cylinder 54. Upon receiving a vibration input that may change the relative position between the upper left arm 42L and the upper right arm 42R, the piston 56 advances/withdraws within the cylinder 54 to move in the axial direction of the cylinder 54. At that time, the movement of the main body of the piston 56 in the cylinder 54 produces a damping force. As a result, displacement vibrations in the linkage 36 are damped. For example, vibrations in the same phase in the upper left arm 42L and the upper right arm 42R, in other words, vibrations in the same phase in the pair of front wheels 14L and 14R are damped by the suspension 38.

As shown in FIG. 2, the damper 40 is attached to the linkage 36. The damper 40 includes a piston 62 and a cylinder 64. The piston 62 is attached to the lower left arm 44L in a swingable manner. The cylinder 64 is attached to the upper right arm 42R in a swingable manner.

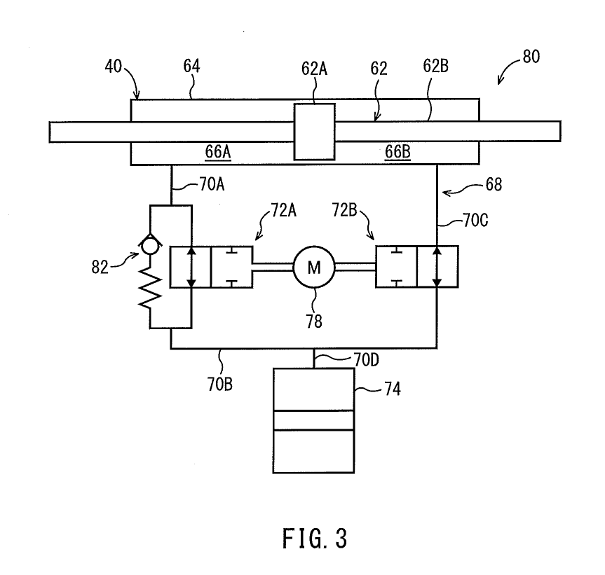

Referring to FIG. 3, a hydraulic circuit that controls the operation of the damper 40 will be described. FIG. 3 is a diagram of the hydraulic circuit for the damper 40.

The piston 62 includes a piston main body 62A and a piston rod 62B. The piston main body 62A is located in a center portion in an axial direction of the piston rod 62B. The piston main body 62A is able to move in the cylinder 64. The piston rod 62B extends through the cylinder 64 in the axial direction. More specifically, the damper 40 is preferably a so-called through-rod damper, for example.

The cylinder 64 stores operating oil. The inside of the cylinder 64 is partitioned into two spaces (a first space 66A and a second space 66B) by the piston main body 62A. The first and second spaces 66A and 66B are connected to each other by a damping circuit 68. The operating oil is therefore able to move between the first and second spaces 66A and 66B through the damping circuit 68.

The damping circuit 68 includes four flow paths 70A, 70B, 70C, and 70D, two flow regulators 72A and 72B, and one temperature compensating chamber 74. The flow regulator 72A is connected to the first space 66A through the flow path 70A. The flow regulator 72A is connected to the flow regulator 72B through the flow path 70B. The flow regulator 72B is connected to the second space 66B through the flow path 70C. The temperature compensating chamber 74 is connected to the flow path 70B through the flow path 70D.

The flow regulators 72A and 72B each include a selector valve 76. The selector valves 76 are actuated by an actuator 78. The actuator 78 is, for example, a motor.

The selector valves 76 each include a valve element and a spring. The valve elements are positioned to block the flow paths in the selector valves 76 by the energizing force of the springs. This prevents the operating oil from flowing in the damping circuit 66. In other words, the operation of the damper 40 is prevented. The prevention of the operation of the damper 40 prevents the operation of the linkage 36. More specifically, the linkage 36 attains a locked state.

The actuator 78 moves the valve element against the energizing force of the spring. At that time, the valve elements are in such a position that they do not block the flow paths in the flow regulators 72A and 72B. Therefore, the operating oil is allowed to flow in the damping circuit 66. In other words, the damper 40 is allowed to operate. When the operation of the damper 40 is thus allowed, vibrations are damped. When, for example, vibrations in opposite phases are generated in the lower left arm 44L and the upper right arm 42R, or when vibrations in opposite phases are generated in the pair of front wheels 14L and 14R, the vibrations are damped by the damper 40. When the operation of the damper 40 is allowed, the operation of the linkage 36 is allowed. In other words, the linkage attains an unlocked state.

As can be clearly understood from the above description, according to a preferred embodiment of the present invention, the damper 40, the damping circuit 66, and the actuator 78 define the lock 80.

Note that in the example shown in FIG. 3, the flow regulator 72A is provided with a relief valve 82. The relief valve 82 is arranged in parallel with the selector valve 76. The relief valve 82 prevents the internal pressure of the cylinder 64 from increasing when the operation of the damper 40 is prevented.

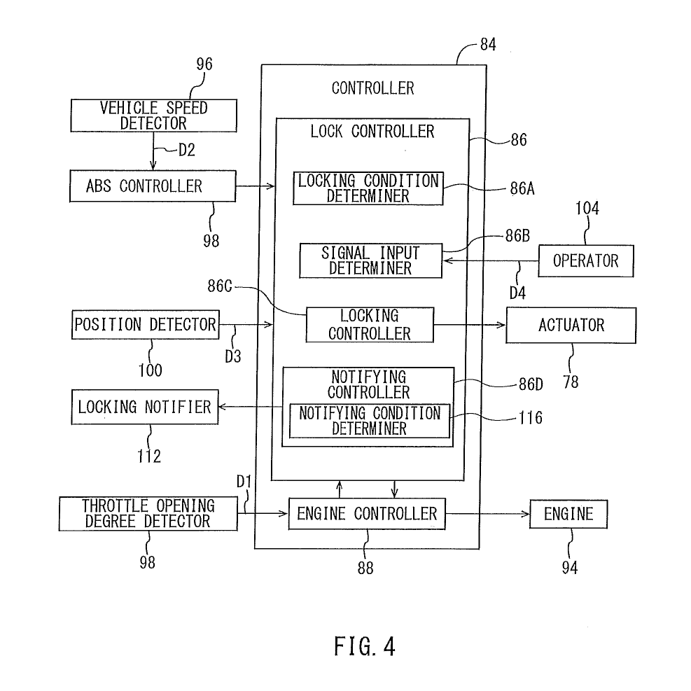

Referring to FIG. 4, a controller 84 provided in the saddle riding type vehicle 10 will be described. FIG. 4 is a block diagram for illustrating signals input/output to/from the controller 84.

The controller 84 is configured or programmed to include a lock controller 86 and an engine controller 88.

The lock controller 86 controls locking and unlocking of the linkage 36 by the lock 80. The lock controller 86 is configured or programmed to include a locking condition determiner 86A, a signal input determiner 86B, and a locking controller 86C.

The locking condition determiner 86A determines whether a prescribed locking condition is fulfilled based on a throttle opening degree signal D1, a vehicle speed signal D2, and a position signal D3. Non-limiting examples of locking conditions will be described below.

The throttle opening degree signal D1 is output by a throttle opening degree detector 90 and represents a throttle opening degree. The throttle opening degree signal D1 is input to the lock controller 86 through the engine controller 88.

The vehicle speed signal D2 is output by a vehicle speed detector 96 and represents a vehicle speed. The vehicle speed detector 96 includes, for example, a wheel speed sensor. According to a preferred embodiment of the present invention, the saddle riding type vehicle 10 includes an ABS (anti-lock braking system). Therefore, the vehicle speed signal D2 is input to the lock controller 86 through an ABS controller 98 that controls the operation of the ABS.

The position signal D3 is output by a position detector 100 and represents the position of the valve elements provided in the selector valves 76. The position detector 100 determines whether the linkage 36 is locked. In short, the position detector 100 outputs a locked position signal as the position signal D3 when the valve elements are positioned to block the flow paths in the selector valves 76. The position detector 100 outputs an unlocked position signal as the position signal D3 when the valve elements are not in positions to block the flow paths in the selector valves 76. The position signal D3 is input to the lock controller 86. The position detector 100 detects the positions of the valve elements included in the selector valves 76, for example, by directly detecting the positions of these valve elements or by detecting the position of the actuator 78 as well as voltage that drives the actuator 78.

The signal input determiner 86B determines whether an operation signal D4 is input while the locking condition is fulfilled. A result of the determination by the locking condition determiner 86A and an operation signal D4 input to the lock controller 86 are used to make the determination.

The operation signal D4 is output by an operator 104. The operator 104 continues to output the operation signal D4 to the lock controller 86 while the rider carries out the operation. The operation signal D4 may be output continuously or intermittently. The operator 104 is positioned so that the rider is able to operate the operator 104. The operator 104 includes, for example, an operation switch provided on the handle 28.

The locking controller 86C controls the lock 80 to lock the linkage 36 if the operation signal D4 is input while the locking condition is fulfilled. More specifically, the locking controller 86C drives the actuator 78 to move the valve elements included in the selector valves 76. In this way, the valve elements block the flow paths in the selector valves 76. As a result, the linkage 36 attains a locked state. Note that a result of the determination from the signal input determiner 86B is used to determine whether the operation signal D4 is input while the locking condition is fulfilled.

The locking controller 86C unlocks the linkage 36 if a prescribed unlocking condition is fulfilled. The unlocking condition may be, for example, the rider's operation of an unlocking switch or a vehicle speed higher than a prescribed vehicle speed. The unlocking switch may be included in the operator 104.

The saddle riding type vehicle 10 further includes a locking notifier 112. The locking notifier 112 notifies the rider of a locked state of the linkage 36. The notification provided by the locking notifier 112 may be anything that is visibly or audibly recognizable by the rider. The notification that is visibly recognizable by the rider may be made using a visual indicator. The visual indicator may be, for example, included in a meter positioned near the handle 28. The notification that is audibly recognizable by the rider may be made using a speaker. The speaker is, for example, included in the meter positioned near the handle 28.

The lock controller 86 is configured or programmed to further include a notifying controller 86D that controls the operation of the locking notifier 112. The notifying controller 86D controls the locking notifier 112 to notify a locked state of the linkage 36 if a notification condition to notify the locked state of the linkage 36 is fulfilled. The notifying controller 86D is configured or programmed to include a notifying condition determiner 116. The notifying condition determiner 116 determines whether a notifying condition is fulfilled based on at least one of the vehicle speed and traveling time while the linkage 36 is locked by the lock 80.

Now, control carried out by the lock controller 86 to lock the linkage 36 (locking control by the lock controller 86) will be described. Note that the locking control performed by the lock controller 86 is not limited to the following example.

The lock controller 86 controls the lock 80 to lock the linkage 36 if the operation signal D4 is input upon fulfillment of a locking condition under which the linkage 36 may be locked. For example, a locking condition is fulfilled if all of the following conditions 1 to 3 are satisfied.
Condition 1: The linkage 36 is in an unlocked state.
Condition 2: The present throttle opening degree is zero.
Condition 3: The present vehicle speed is lower than a prescribed vehicle speed.

Now, referring to FIG. 5, the locking control by the lock controller 86 will be described. FIG. 5 is a flowchart for illustrating the locking control by the lock controller 86.

First, the lock controller 86 determines in step S1 whether the locking condition is established. More specifically, the locking condition determiner 86A determines whether all of the above-described conditions 1 to 3 are satisfied.

The locking condition determiner 86A determines whether the linkage 36 is in an unlocked state by referring to an input position signal D3. If an unlocked position signal D3 is input, the condition 1 is satisfied.

The locking condition determiner 86A determines whether the present throttle opening degree is zero by referring to an input throttle opening degree signal D1. If the throttle opening degree is zero, in other words, if the throttle valve is closed, the condition 2 is satisfied.

The locking condition determiner 86A determines whether the present vehicle speed is lower than a prescribed vehicle speed (about 10 km/h, for example) by referring to an input vehicle speed signal D2. If the present vehicle speed is lower than the prescribed vehicle speed, the condition 3 is satisfied.

Unless at least one of the conditions 1 to 3 is satisfied, the lock controller 86 ends the locking control. On the other hand, if all of the conditions 1 to 3 are satisfied, the lock controller 86 determines in step S2 whether the rider intends to lock the linkage 36. More specifically, the signal input determiner 86B determines whether an input condition is fulfilled. For example, an input condition is fulfilled if the following condition 4 is satisfied.
Condition 4: The operation signal D4 is input.

The signal input determiner 86B determines whether the operation signal D4 is input. If the operation signal D4 is input, the condition 4 is satisfied.

The operation signal D4 may be input before or after the locking condition is fulfilled.

If the condition 4 is not satisfied, the lock controller 86 ends the locking control. On the other hand, if the condition 4 is satisfied, the lock controller 86 locks the linkage 36 in step S3. More specifically, the locking controller 86C drives the actuator 78 to lock the linkage 36. The lock controller 86 subsequently ends the locking control.

Now, notifying control by the notifying controller 86D will be described. The notifying controller 86D controls the locking notifier 112 to notify a locked state of the linkage 36 if a notifying condition is fulfilled.

For example, a notifying condition is established when the vehicle has travelled for a prescribed period (about three seconds, for example) at a vehicle speed lower than a vehicle speed at the time of locking of the linkage 36. The vehicle speed does not have to be constant for the prescribed period.

Now, referring to FIG. 6, the notifying control by the notifying controller 86D will be described. FIG. 6 is a flowchart for illustrating the notifying control by the notifying controller 86D.

First, in step S11, the notifying controller 86D determines whether the linkage 36 is in a locked state. More specifically, the notifying controller 86D refers to an input position signal D3 and determines whether the linkage 36 is locked. If a locked position signal D3 is input, the linkage 36 is locked.

If the linkage 36 is not locked (NO in step S11), the notifying controller 86D ends the notifying control. On the other hand, if the linkage 36 is locked (YES in step S11), the notifying controller 86D determines in step S12 whether the notifying condition is fulfilled. More specifically, the notifying condition determiner 116 determines whether the vehicle has travelled at a vehicle speed lower than a vehicle speed at the time of locking the linkage 36.

If the notifying condition is not satisfied (NO in step S12), the notifying controller 86D ends the notifying control. On the other hand, if the notifying condition is fulfilled (YES in step S12), the notifying controller 86D carries out notification by the locking notifier 112 in step S13. More specifically, the notifying controller controls the operation of the locking notifier 112 to notify the rider of the locked state of the linkage 36. The notifying controller 86D subsequently ends the notifying control.

Note that the notification by the locking notifier 112 may end if, for example, the linkage 36 is unlocked or the notifying condition is no longer fulfilled.

If the saddle riding type vehicle 10 has traveled for a prescribed time period at a vehicle speed lower than a vehicle speed at the time of locking of the linkage 36, a locked state of the linkage 36 is notified. Therefore, an actual state of the linkage 36 and a state of the linkage 36 understood by the rider are the same or substantially the same.

The notifying condition may be established when the vehicle speed is at least a first vehicle speed while the linkage 36 is locked. Here, the first vehicle speed is lower than the vehicle speed at the time of locking of the linkage 36, but not zero. The first vehicle speed is, for example, about 6 km/h.

Under the notifying condition, immediately after the linkage 36 is locked, the locked state of the linkage 36 is notified. It is thus easier to make the rider aware of the locked state of the linkage 36.

If the above-described notifying condition is used, the notification by the locking notifier 112 may end when the present vehicle speed becomes lower than the first vehicle speed. If the notification by the locking notifier 112 is made by sound as well as by an indicator, the notification by sound may end when, for example, the present vehicle speed becomes lower than the first vehicle speed.

In a preferred embodiment of the present invention, the notifying condition may be established if the vehicle speed, while the linkage 36 is locked, is higher than the first vehicle speed.

The notifying condition may be established after a prescribed time (three seconds for example) after the linkage 36 is locked. When a certain time passes after the linkage 36 is locked, the rider may not correctly recognize the state of the linkage 36. Thus, the rider is aware of the state of the linkage 36 in such a case.

The notifying condition may be established when the vehicle travels for a prescribed time period at a prescribed vehicle speed or higher while the linkage 36 is locked. The vehicle speed does not have to be constant for the prescribed time period. If the notifying condition is used, the notification by the locking notifier 112 may end based on the same requirement as the case of using the notifying condition described above.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-6. (canceled)

7. A saddle riding type vehicle comprising:
a vehicle body frame;
a pair of front wheels;
a linkage that connects the pair of front wheels to the vehicle body frame;
a lock that locks the linkage by preventing operation of the linkage and unlocks the linkage by allowing the linkage to operate;
a controller that controls locking and unlocking of the linkage by the lock; and
a notifier that notifies a rider when the vehicle travels and the lock has locked the linkage.

8. The saddle riding type vehicle according to claim 7, wherein the notifier notifies the rider when the vehicle travels at least at a prescribed vehicle speed and the lock has locked the linkage.

9. The saddle riding type vehicle according to claim 7, wherein the notifier notifies the rider when the vehicle has travelled for a prescribed period and the lock has locked the linkage.

10. The saddle riding type vehicle according to claim 7, wherein the notifier notifies the rider that the linkage is locked by the lock if the lock has locked the linkage and the vehicle travels for a prescribed period at a vehicle speed lower than a vehicle speed at the time of locking the linkage.

11. The saddle riding type vehicle according to claim 7, further comprising a notifying condition determiner that determines whether a notifying condition that indicates a locked state of the linkage is fulfilled based on at least one of a vehicle speed and a traveling time and the lock has locked the linkage; and
a notifying controller that controls the notifier to notify the locked state of the linkage if the notifying condition is fulfilled.

12. The saddle riding type vehicle according to claim 7, further comprising a damper that damps vibrations in opposite phases generated in the pair of front wheels, wherein the lock locks the linkage by preventing operation of the damper and unlocks the linkage by allowing the damper to operate.
